(19) United States
(12) Patent Application Publication
(10) Pub. No.: US 2013/0330044 A1
(43) Pub. Date: Dec. 12, 2013

(54) OPTICAL CONNECTOR WITH REDUCED SIZE

(71) Applicant: Hon Hai Precision Industry Co. Ltd., New Taipei (TW)

(72) Inventor: KAI-WEN WU, New Taipei (TW)

(73) Assignee: HON HAI PRECISION INDUSTRY CO., LTD., New Taipei (TW)

(21) Appl. No.: 13/964,347

(22) Filed: Aug. 12, 2013

(30) Foreign Application Priority Data
Mar. 7, 2012 (TW) 102108138

(51) Int. Cl. G02B 6/42

(52) U.S. Cl. CPC G02B 6/4214
USPC 385/76; 385/89

(57) ABSTRACT

An optical connector includes a substrate, a number of light emitters, a number of light receivers, and a lens module. The light emitters and the light receivers are positioned on the substrate. The lens module is positioned on the substrate, and the light emitters and the light receivers are received in the lens module. The lens module includes a reflection surface, a number of first lenses, and a number of second lenses. Optical axes of the first lenses cross optical axes of the second lenses on the reflection surface. The first lenses are aligned with the light emitters and the light receivers.

### BACKGROUND

1. Technical Field

The present disclosure relates to optical connectors, and particularly to an optical connector having a reduced size.

2. Description of Related Art

Optical connectors include a substrate, a number of light emitters for emitting light signals, and a number of light receivers for receiving light signals. To avoid light signals interfering with each other, the light emitters and the light receivers are linearly arranged on the substrate and spaced from each other, which increases a size of the optical connector.

Therefore, it is desirable to provide an optical connector that can overcome the limitations described.

### BRIEF DESCRIPTION OF THE DRAWINGS

FIG. 1 is an exploded top view of an optical connector in accordance with an exemplary embodiment.

FIG. 2 is a top view of the assembled optical connector of FIG. 1.

FIG. 3 is a cross-sectional view taken along a line of FIG. 2.

FIG. 4 is a cross-sectional view taken along a line IV-IV of FIG. 2.

### DETAILED DESCRIPTION

Embodiments of the disclosure will be described with reference to the drawings.

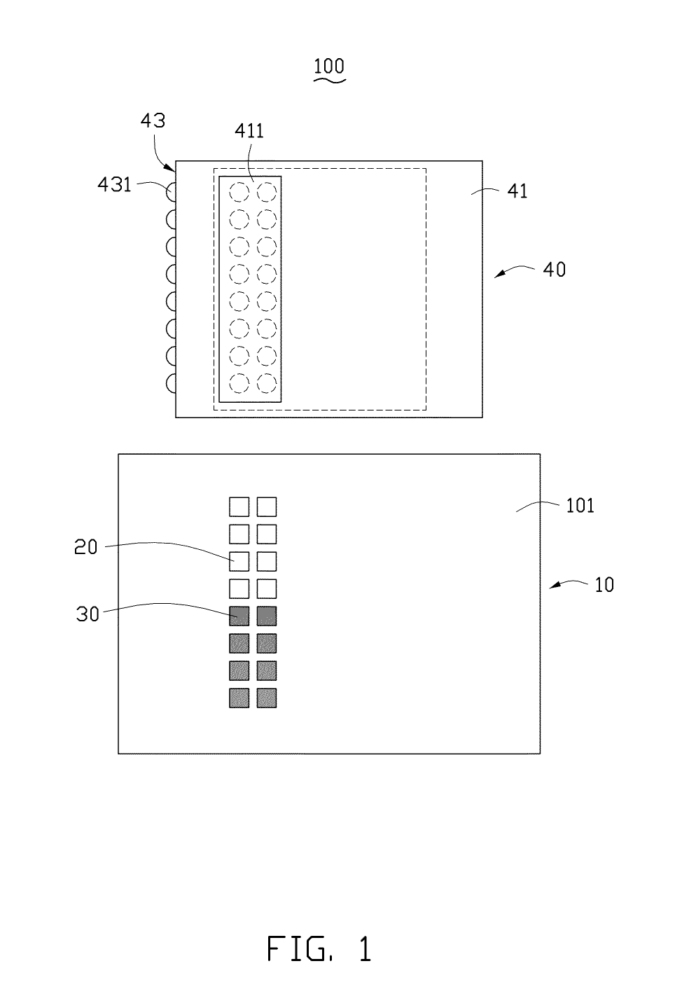

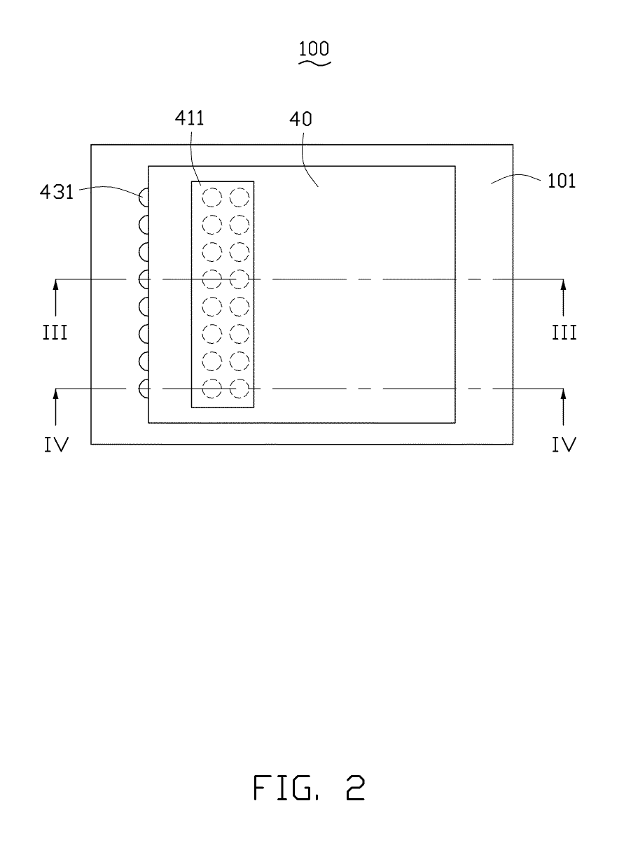

FIGS. 1-4 show an optical connector 100 according to an exemplary embodiment. The optical connector 100 includes a substrate 10, a number of light emitters 20, such as laser diodes, a number of light receivers 30, such as photo diodes, and a lens module 40.

The substrate 10 is a printed circuit board and includes a bearing surface 101.

The light emitters 20 are positioned on the bearing surface 101 and are electronically connected to the substrate 10. The light emitters 20 convert electronic signals into corresponding light signals in a form of light rays.

The light receivers 30 are positioned on the bearing surface 101 and are electronically connected to the substrate 10. The light receivers 30 receive and convert light rays into corresponding electronic signals.

A number of the light emitters 20 is equal to a number of the light receivers 30. The light emitters 20 and the light receivers 30 are arrayed in at least two rows. In the embodiment, the optical connector 100 includes eight light emitters 20 and eight light receivers 30. The light emitters 20 and the light receivers 30 are arrayed in two rows.

In the embodiment, four of the eight light emitters 20 and four of the eight light receivers 30 are arrayed in one line, and another four light emitters 20 and another four light receivers 30 are arrayed in another line.

Configurations, such as the numbers and arrangement of the light emitters 20 and the light receivers 30, are not limited to this embodiment.

The lens module 40 is substantially rectangular and is made of transparent material, such as plastic or glass. The lens module 40 includes a top surface 41, a connecting surface 42, and a side surface 43. The connecting surface 42 is opposite to the top surface 41, and the side surface 43 is substantially perpendicularly connected between the top surface 41 and the connecting surface 42.

The lens module 40 defines an elongated first recess 411 in the top surface 41, and a cross-section of the first recess 411 taken along a direction that is substantially perpendicular to a lengthwise direction of the recess 411 is V-shaped. The first recess 411 includes an inner surface 4111 substantially perpendicular to the top surface 41 and a reflection surface 4112 tilting about 45 degrees relative to the inner surface 4111. The lens module 40 defines a substantially rectangular second recess 421 in the connecting surface 42. The second recess 421 includes a bottom surface 4211 substantially parallel to the connecting surface 42.

A number of first lenses 4212 are formed on the bottom surface 4211, located within an orthogonal projection of the reflection surface 4112 onto the bottom surface 4211. In the embodiment, the first lenses 4212 are convex lenses. The first lenses 4212 are arrayed in at least two rows and face the reflection surface 4112. Each first lens 4212 is aligned with either one of the light emitters 20 or one of the light receivers 30. In the embodiment, a number of the first lenses 4212 is equal to a total number of the light emitters 20 and the light receivers 30. Therefore, there are sixteen first lenses 4212. An optical axis O of each first lens 4212 is parallel to the inner surface 4111, and tilts about 45 degrees relative to the reflection surface 4112.

A number of second lenses 431 is formed on the side surface 43, located within an orthogonal projection of the reflection surface 4112 onto the side surface 43. In the embodiment, the second lenses 431 are convex lenses. The second lenses 431 are arrayed in at least two rows and face the reflection surface 4112. An arrangement of the second lenses 431 is the same as an arrangement of the first lenses 4212. In the embodiment, the number of the second lenses 431 is equal to the number of the first lenses 4212. Therefore, there are sixteen second lenses 431. An optical axis A of each second lens 431 is parallel to the top surface 41, and tilts about 45 degrees relative to the reflection surface 4112. The optical axes O of the first lenses 4212 cross the optical axes A of the second lenses 431 on the reflection surface 4112.

In assembly, the light emitters 20 and the light receivers 30 are mounted on the bearing surface 101 by a surface-mount technology (SMT). The lens module 40 is positioned on the substrate 10, and the connecting surface 42 is connected to the bearing surface 101. The light emitters 20 and the light receivers 30 are received in the second recess 421. The second recess 421 is sealed by the substrate 10. In the embodiment, the connecting surface 42 is attached to the bearing surface 101 via glue. The reflection surface 4112 tilts about 45 degrees relative to the bearing surface 101, and the bottom surface 4211 is parallel to the bearing surface 101. The first lenses 4212 face the light emitters 20 and the light receivers 30. The optical axes O of the first lenses 4212 are aligned with the light emitters 20 and the light receivers 30.

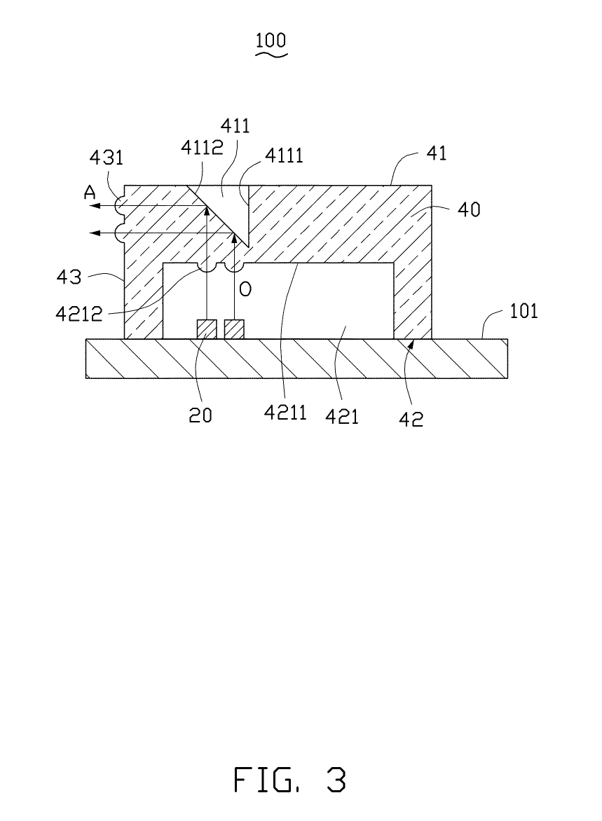

Referring to FIG. 3, during the process of emitting the light rays, the light emitters 20 emit light rays to the first lenses 4212 along a direction perpendicular to the bottom surface 4211. The light rays are converged by the first lenses 4212, and are projected onto the reflection surface 4112. The reflection surface 4112 reflects the light rays to the second lenses 431. The light rays are converged by the second lenses 431, and are emitted from the optical connector 100 to the optical fiber.

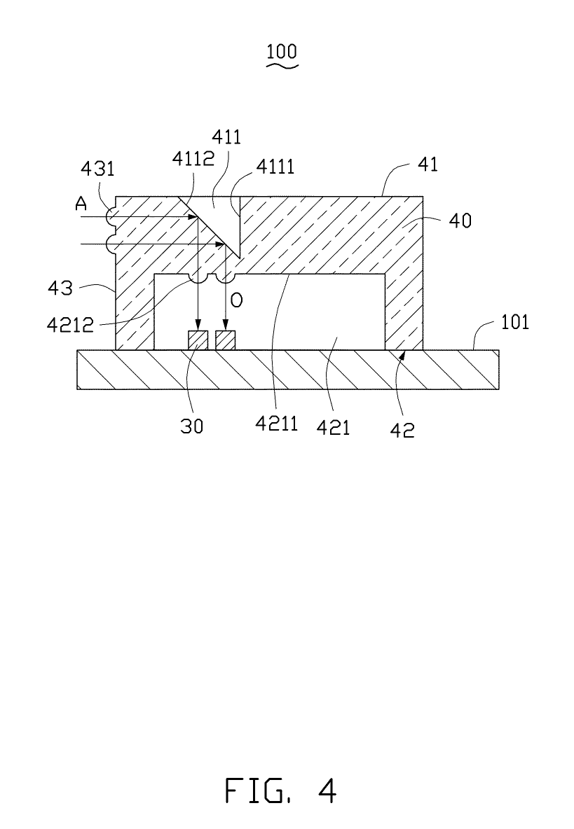

Referring to FIG. 4, during the process of receiving light rays, the light rays emitting from the optical fiber enter into the optical connector 100 through the second lenses 431. The light rays are converged by the second lenses 431, and are projected onto the reflection surface 4112. The reflection surface 4112 reflects the light rays to the first lenses 4212. The light rays are converged by the first lenses 4212, and are projected to the light receivers 30. The light receivers 30 convert the light rays into electronic signals, and the electronic signals are transmitted to an electronic device.

In three other embodiments, the number of the light emitters 20 and the light receivers 30 is four, twelve, and sixteen, respectively. Therefore, the number of the first lenses 4212 and the second lenses 431 is eight, twenty-four, and thirty-two correspondingly. When the number of the light emitters 20 and the light receivers 30 is four, the light emitters 20 and the light receivers 30 are arrayed in two rows, and the first lenses 4212 and the second lenses 431 are arrayed in two rows correspondingly. When the number of the light emitters 20 and the light receivers 30 is twelve, the light emitters 20 and the light receivers 30 are arrayed in three rows, and the first lenses 4212 and the second lenses 431 are arrayed in three rows correspondingly. When the number of the light emitters 20 and the light receivers 30 is sixteen, the light emitters 20 and the light receivers 30 are arrayed in four rows, and the first lenses 4212 and the second lenses 431 are arrayed in four rows correspondingly. Therefore, the arrangement of the light emitters 20, the light receivers 30, the first lenses 4212, and the second lenses 431 into rows allows the optical connector to maintain a reduced size.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An optical connector, comprising:
a substrate comprising a bearing surface;
a plurality of light emitters positioned on the bearing surface;
a plurality of light receivers positioned on the bearing surface; the light emitters and the light receivers arrayed in at least two rows;
a lens module positioned on the bearing surface, and comprising a top surface, a connecting surface opposite to the top surface, and a side surface connected between the top surface and the connecting surface; the lens module defining a first recess on the top surface and a second recess on the connecting surface; the first recess comprising a reflection surface tilting about 45 degrees relative to the bearing surface; the second recess comprising a bottom surface parallel to the bearing surface; the reflection surface facing the side surface and the bottom surface;
a plurality of first lenses on the bottom surface, the first lenses arrayed in at least two rows; and
a plurality of second lenses on the side surface, the second lenses arrayed in at least two rows; optical axes of the first lenses crossing optical axes of the second lenses on the reflection surface; the first lenses aligned with the light emitters and the light receivers.

2. The optical connector of claim 1, wherein a number of the first lenses is equal to a total number of the light emitters and the light receivers, and a number of the second lenses is equal to a total number of the light emitters and the light receivers.

3. The optical connector of claim 1, wherein the light emitters and the light receivers are received in the second recess.

4. The optical connector of claim 1, wherein each first lens is aligned with one of the light emitters and the light receivers, the second lenses is optically aligned with the first lenses.

5. The optical connector of claim 1, wherein the substrate is a printed circuit board, and the light emitters and the light receivers are electrically connected to the printed circuit board.

6. The optical connector of claim 1, wherein a number of the light emitters is equal to a number of the light receivers.

7. The optical connector of claim 1, wherein a number of the first lenses is equal to a number of the second lenses.

8. The optical connector of claim 1, wherein the second recess is sealed by the substrate.

9. The optical connector of claim 1, wherein the first lenses face the reflection surface, and the second lenses face the reflection surface.

10. An optical connector, comprising:
a lens module comprising a top surface, a connecting surface opposite to the top surface, and a side surface connected between the top surface and the connecting surface; the lens module defining a first recess on the top surface and a second recess on the connecting surface; the first recess comprising a reflection surface tilting about 45 degrees relative to the bearing surface; the second recess comprising a bottom surface parallel to the bearing surface; the reflection surface facing the side surface and the bottom surface;
a plurality of first lenses on the bottom surface, the first lenses arrayed in at least two rows; and
a plurality of second lenses on the side surface, the second lenses arrayed in at least two rows; optical axes of the first lenses crossing optical axes of the second lenses on the reflection surface.

11. The optical connector of claim 10, wherein a number of the first lenses is equal to a number of the second lenses.

12. The optical connector of claim 10, wherein an arrangement of the first lenses is same as an arrangement of the second lenses.

13. The optical connector of claim 10, wherein the first lenses face the reflection surface, and the second lenses face the reflection surface.
